(19) United States
(12) Patent Application Publication
(10) Pub. No.: US 2009/0104489 A1
(43) Pub. Date: Apr. 23, 2009

(54) AIR BREATHING TYPE POLYMER ELECTROLYTE MEMBRANE FUEL CELL AND OPERATING METHOD THEREOF

(75) Inventors: Seung-Shik Shin, Gyeonggi-do (KR); Ho-Jin Kweon, Gyeonggi-do (KR); Mee-Young Lee, Gyeonggi-do (KR); Seok-Rak Chang, Gyeonggi-do (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Gyeonggi-do (KR)

(21) Appl. No.: 12/134,903

(22) Filed: Jun. 6, 2008

(30) Foreign Application Priority Data
Oct. 17, 2007 (KR) 10-2007-0104600

(51) Int. Cl. H01M 8/04; H01M 8/00

(52) U.S. Cl. 429/23; 429/13; 429/24

(57) ABSTRACT

An air-breathing-type polymer electrolyte membrane fuel cell and an operating method thereof capable of being stably started and operated by controlling an output current and temperature of a fuel cell stack in a predetermined range is controlled in a predetermined range so that the initial driving time of the system can be shortened through the high current operation in the low output state. The operating method of the air-breathing-type polymer electrolyte membrane fuel cell includes the steps of detecting an output current of a fuel cell stack; comparing a maximum reference value and a minimum reference value of the detected output current; and keeping the output current below the maximum reference value and above the minimum reference value.

### CROSS-REFERENCE TO RELATED APPLICATION

This application claims priority to and the benefit of Korean Patent Application No. 10-2007-0104600, filed on Oct. 17, 2007 in the Korean Intellectual Property Office, the entirety of which is incorporated herein by reference.

### BACKGROUND

1. Technical Field

The present disclosure relates to an air-breathing-type polymer electrolyte membrane fuel cell and an operating method thereof.

2. Discussion of Related Art

Since a fuel cell is a pollution-free power supply apparatus, it has been spotlighted as a next generation clean energy power generation system. A power generation system using a fuel cell can advantageously be used as an on-site generator for a large building, a power supply for an electric vehicle, a portable power supply, etc., and can use various fuels such as natural gas, city gas, naphtha, methanol, waste gas, etc. All fuel cells operate on the same basic principle, and can be classified into molten carbonate fuel cells (MCFC), solid oxide fuel cells (SOFC), polymer electrolyte membrane fuel cells (PEFC), phosphoric acid fuel cells (PAFC), alkaline fuel cells (AFC), etc., according to the kind of electrolyte used.

Of these types, polymer electrolyte fuel cells are further divided into polymer electrolyte membrane fuel cells or proton exchange membrane fuel cells (PEMFC), and direct methanol fuel cells (DMFC) in accordance the type of fuel used. Since a polymer electrolyte membrane fuel cell uses a solid polymer as an electrolyte, it has no risk of corrosion or evaporation from the electrolyte, and can provide a high current density per unit area. Moreover, since a polymer electrolyte membrane fuel cell has very high output characteristics and low operating temperatures compared with other kinds of fuel cells, it has been actively developed as a portable power supply for vehicles, as a distributed power supply for houses and/or public buildings, and a small power supply for electronic equipment, etc.

Furthermore, some polymer electrolyte fuel cells comprise air-breathing-type PEMFC systems in which an anode uses pure hydrogen or a hydrogen gas mixture as the fuel and a cathode that draws ambient air by convection. An air-breathing-type PEMFC system can omit an apparatus for actively supplying outside air to the cathode, thereby simplifying manufacturing and lowering manufacturing costs compared with other types of PEMFC systems.

However, in the air-breathing-type PEMFC system, it is difficult to control a rise in temperature of a stack an initial driving or start-up of the system. In particular, it is difficult to control the heat generated by a stack or fuel reformer themselves. For example, the air-breathing-type PEMFC system does not usually control the rise temperature of the stack in the initial driving. Consequently, when the stack temperature rises to an undesired high temperature from heat generated by high-output operation, a membrane, an electrode, or an MEA comprising a combination thereof within the stack, is dehydrated, thereby causing the stack output to rapidly drop instead of rising to a desired value.

Also, an air-breathing-type PEMFC system may keep the stack temperature low by reducing stack output in the initial driving and/or by low output operation. Under these conditions, moisture generated in the cathode is easily condensed, thereby frequently causing cathode flooding that occludes an air vent of the cathode.

Therefore, in the air-breathing-type PEMFC system, there is a need for a system in which the MEA does not dehydrate even at high temperatures, that is, an MEA suitable for a high output and a high temperature operation. However, such an MEA has been not yet been developed.

### SUMMARY OF THE INVENTION

It is an object to provide method for operating an air-breathing-type polymer electrolyte membrane fuel cell that does not degrade stack performance due to dehydration of the MEA and/or cathode flooding under high output and/or high temperature operation.

It is another object to provide a highly reliable air-breathing-type polymer electrolyte membrane fuel cell system using the foregoing operating method.

In order to accomplish the above and other objects, one aspect provides a method for operating an air-breathing-type polymer electrolyte membrane fuel cell having a fuel cell stack comprising an anode electrode, a cathode electrode, and a polymer electrolyte membrane positioned between the anode electrode and the cathode electrode, the method comprising the steps of: detecting an output current of a fuel cell stack; comparing a maximum reference value and a minimum reference value to the detected output current; and keeping the output current below the maximum reference value and above the minimum reference value.

Another aspect provides a method for operating an air-breathing-type polymer electrolyte membrane fuel cell having a fuel cell stack comprising an anode electrode, a cathode electrode, and a polymer electrolyte membrane positioned between the anode electrode and the cathode electrode, the method comprising: detecting a temperature of a fuel cell stack; comparing a maximum reference value and a minimum reference value to the detected stack temperature; and keeping the stack temperature below the maximum reference value and above the minimum reference value.

Another aspect provides a method for operating an air-breathing-type polymer electrolyte membrane fuel cell having a fuel cell stack comprising an anode electrode, a cathode electrode, and a polymer electrolyte membrane positioned between the anode electrode and the cathode electrode, the method comprising: detecting output current and temperature of a fuel cell stack; comparing a maximum reference value and a minimum reference value to the detected output current and temperature, respectively; and keeping each of the output current and temperature below the maximum reference value and above the minimum reference value.

Another aspect provides an air-breathing-type polymer electrolyte membrane fuel cell having a fuel cell stack comprising an anode electrode, a cathode electrode, and a polymer electrolyte membrane positioned between the anode electrode and the cathode electrode, the fuel cell comprising: an electric generator generating electric energy by an electrochemical reaction of fuel supplied to an anode electrode and oxidant supplied by natural convection; a fuel supplier supplying fuel to the anode electrode; a detector detecting an output current generated in the electric generator; and a controller comparing an output current value obtained from the detector with preset maximum reference value and minimum reference value and driving a performance keeping means to keep the output current value below the maximum reference value and above the minimum reference value.

Another aspect provides an air-breathing-type polymer electrolyte membrane fuel cell having a fuel cell stack comprising an anode electrode, a cathode electrode, and a polymer electrolyte membrane positioned between the anode electrode and the cathode electrode, the fuel cell comprising: an electric generator generating electric energy by an electrochemical reaction of fuel supplied to an anode electrode and oxidant supplied by natural convection; a fuel supplier supplying fuel to the anode electrode; a detector detecting a temperature of the electric generator; and a controller comparing a temperature value obtained from the detector with preset maximum reference value and minimum reference value and driving a performance keeping means to keep the temperature value below the maximum reference value and above the minimum reference value.

Another aspect provides an air-breathing-type polymer electrolyte membrane fuel cell having a fuel cell stack comprising an anode electrode, a cathode electrode, and a polymer electrolyte membrane positioned between the anode electrode and the cathode electrode, the fuel cell comprising: an electric generator generating electric energy by an electrochemical reaction of fuel supplied to an anode electrode and oxidant supplied by a natural convection; a fuel supplier supplying fuel to the anode electrode; a detector detecting an output current generated in the electric generator and a temperature of the electric generator; and a controller comparing an output current value obtained from the detector with preset maximum current reference value and minimum current reference value and a temperature value obtained from the detector with preset maximum reference value and minimum reference value and when the output current value or the temperature value is out of the range of the minimum reference value or the maximum reference value, driving a performance keeping means.

Some embodiments provide an air-breathing-type polymer electrolyte membrane fuel cell and a method for operating the same. The air-breathing-type polymer electrolyte membrane fuel cell comprises an electric generator comprising a fuel cell stack comprising an anode, a cathode, and a polymer electrolyte membrane disposed therebetween. The anode is fluidly connected to a suitable fuel source. Oxygen from the atmosphere is supplied to the cathode by convection. The fuel cell system further comprises one or more sensors or detectors, measuring a state of the stack, for example, an output current of the stack and/or a temperature of the stack. An output of the sensor is coupled to a controller, which compares the output with minimum and maximum values for the detected state. The controller maintains the detected state between the minimum and maximum values by modifying one or more conditions of the stack, for example, at least one of increasing the output current of the stack, cooling the stack, electrically coupling an internal load to the stack, electrically coupling an external load to a supplemental power source, and the like.

Some embodiments provide a method for operating an air-breathing-type polymer electrolyte membrane fuel cell comprising a fuel cell stack comprising an anode electrode, a cathode electrode, and a polymer electrolyte membrane disposed therebetween. The method comprises: detecting an output current of a fuel cell stack; comparing the detected output current with a maximum reference current and a minimum reference current; and maintaining the output current below the maximum reference current and above the minimum reference current.

Some embodiments further comprise electrically coupling a secondary power source to an external load electrically coupled to the fuel cell stack when the output current exceeds the maximum reference current. Some embodiments further comprise electrically isolating the fuel cell stack from the load for a predetermined time. Some embodiments further comprise electrically coupling a separate internal load with predetermined resistance to the fuel cell stack in addition to an external load electrically coupled thereto when the output current is below the minimum reference current.

In some embodiments, the maximum reference current is about 600 mA/cm² and the minimum reference current is about 200 mA/cm².

In some embodiments, at least one of the anode electrode and the cathode electrode comprises a catalyst layer, a diffusion layer, and a microporous layer.

Some embodiments provide a method for operating an air-breathing-type polymer electrolyte membrane fuel cell comprising a fuel cell stack comprising an anode electrode, a cathode electrode, and a polymer electrolyte membrane disposed therebetween, the method comprising: detecting a temperature of a fuel cell stack; comparing the detected temperature with a maximum reference temperature and a minimum reference temperature; and maintaining the stack temperature below the maximum reference temperature and above the minimum reference temperature.

Some embodiments further comprise cooling the fuel cell stack using a cooling device coupled to the fuel cell stack where the stack temperature exceeds the maximum reference temperature. Some embodiments further comprise electrically coupling an internal variable resistor to the fuel cell stack, thereby operating the fuel cell stack for a predetermined time at an output current density exceeding a maximum output current density where the fuel cell stack temperature is below the minimum reference temperature.

In some embodiments, the maximum reference temperature is about 50° C. and the minimum reference temperature is about 36° C.

Some embodiments provide a method for operating an air-breathing-type polymer electrolyte membrane fuel cell comprising a fuel cell stack comprising an anode electrode, a cathode electrode, and a polymer electrolyte membrane disposed therebetween, the method comprising: detecting an output current and a temperature of a fuel cell stack; comparing the detected output current to a maximum reference current and a minimum reference current, and comparing the detected temperature to a maximum reference temperature and a minimum reference temperature; and maintaining the output current below the maximum reference current and above the minimum reference current, and maintaining the temperature below the maximum reference temperature and above the minimum reference temperature.

Some embodiments further comprise electrically coupling a secondary power source to a load electrically coupled to the fuel cell stack and cooling the fuel cell stack using a cooling device coupled to the fuel cell stack when the output current and stack temperature exceed their respective maximum reference values. Some embodiments further comprise electrically coupling a separate internal load with predetermined capacity to the fuel cell stack in addition to an external load electrically coupled thereto when the output current and stack temperature are below their minimum reference values.

Some embodiments provide an air-breathing-type polymer electrolyte membrane fuel cell comprising: a fuel cell stack comprising an anode electrode, a cathode electrode, and a polymer electrolyte membrane positioned therebetween; an electric generator comprising the fuel cell stack and operable for generating electric energy by an electrochemical reaction between a fuel supplied to the anode electrode and oxygen is supplied to the cathode by convection; a fuel supplier fluidly connected to the anode electrode; an output current detector electrically coupled to the electric generator; and a controller electrically coupled to the output current detector, and driving at least one performance maintenance device operable to maintain an output current value below a maximum reference current value and above a minimum reference current value.

In some embodiments, the performance maintenance device comprises a secondary power supply; and an internal load, the controller is configured to electrically couple and uncouple an external load to and from one or both of the electric generator and the secondary power supply, the controller is configured to electrically couple and uncouple the internal load to and from the electric generator, the controller is configured to electrically couple the secondary power supply to the external load when the output current value exceeds the maximum reference current value, and the controller is configured to electrically couple the internal load to the electric generator in addition to the external load when the output current value is below the minimum reference current value.

Some embodiments provide an air-breathing-type polymer electrolyte membrane fuel cell comprising: a fuel cell stack comprising an anode electrode, a cathode electrode, and a polymer electrolyte membrane disposed therebetween; an electric generator comprising the fuel cell stack and operable for generating electric energy by an electrochemical reaction between a fuel supplied to an anode electrode and oxygen supplied to the cathode by convection; a fuel supplier fluidly connected to the anode electrode; a temperature detector operable for detecting a temperature of the electric generator; and a controller electrically coupled to an output of the temperature controller and driving at least one performance maintaining device operable to maintain the temperature of the electric generator below a maximum reference temperature value and above a minimum reference temperature value.

In some embodiments, the performance maintaining device comprises a cooling device configured for cooling the electric generator and an internal variable resistor electrically coupled to the electric generator through a switch, the controller is configured to activate the cooling means, thereby cooling the electric generator when the temperature of the electric generator exceeds the maximum reference temperature value, and the controller is configured to electrically couple the variable resistor to the electric generator and adjusts the resistance value of the variable resistor, thereby adjusting the output current of the electric generator to about a maximum reference current value when the temperature of the electric generator is below the minimum reference temperature value.

Some embodiments provide an air-breathing-type polymer electrolyte membrane fuel cell comprising: a fuel cell stack comprising an anode electrode, a cathode electrode, and a polymer electrolyte membrane disposed therebetween; an electric generator comprising the fuel cell stack, operable for generating electric energy by an electrochemical reaction between a fuel supplied to the anode electrode and oxygen supplied to the cathode by convection; a fuel supplier fluidly connected to the anode electrode; a detector configured for detecting an output current of the electric generator and a temperature of the electric generator; and a controller electrically coupled to the output of the detector and configured for driving at least one performance maintaining device operable maintain at least one of the output current and temperature their respective predetermined minimum reference value and maximum reference value.

In some embodiments, the performance maintaining device comprises a secondary power supply; a cooling device configured for cooling the electric generator; and a variable resistor coupled to the electric generator through a switch, and the controller is configured to electrically couple and uncouple an external load to and from one or both of the electric generator and the secondary power supply, the controller is configured to activate and deactivate the cooling device, the controller is configured to electrically couple and uncouple the internal load to and from the electric generator, the controller is configured to electrically couple the secondary power supply to the external load and activates the cooling device, thereby cooling the electric generator when at least one of the output current value and the temperature value exceeds their respective maximum reference values, and the controller electrically couples the variable resistor to the electric generator and adjusts the resistance thereof, thereby adjusting the output current value of the electric generator to equal to or larger than a maximum reference current value when at least one of the output current value and the temperature value is below the minimum reference value.

### BRIEF DESCRIPTION OF THE DRAWINGS

These and/or other embodiments and features will become apparent and more readily appreciated from the following description of certain exemplary embodiments, taken in conjunction with the accompanying drawings of which:

FIG. 1 is a flow chart of an embodiment of a method for operating an air-breathing-type polymer electrolyte membrane fuel cell;

FIG. 2 is a flow chart of an embodiment of a method for operating an air-breathing-type polymer electrolyte membrane fuel cell;

FIG. 3 is a flow chart of an embodiment of a method for operating an air-breathing-type polymer electrolyte membrane fuel cell;

FIG. 4 is a schematic view of an embodiment of an air-breathing-type polymer electrolyte membrane fuel cell useful in the method for operating the fuel cell according;

FIG. 5 is a schematic view of embodiment of an electric generator useful in an air-breathing-type electrolyte membrane fuel cell;

FIG. 6 is a graph of current density and temperature of a stack of a general air-breathing-type polymer electrolyte membrane fuel cell; and

FIG. 7 is a graph of current density and temperature of a stack of a general air-breathing-type polymer electrolyte membrane fuel cell operated according to an embodiment of the method for operating the fuel cell.

### DETAILED DESCRIPTION OF CERTAIN EMBODIMENTS

Hereinafter, certain exemplary embodiments will be described with reference to the accompanying drawings. Here, when a first element is described as being coupled to a second element, the first element may be directly coupled to the second element or may also be indirectly coupled to the second element through one or more third elements. Further, elements that are not essential for a complete understanding are omitted for clarity. Also, like reference numerals refer to like elements throughout.

Hereinafter, exemplary embodiments will be described in a more detailed manner with reference to the accompanying drawings in order for those skilled in the art to easily carry out the embodiments.

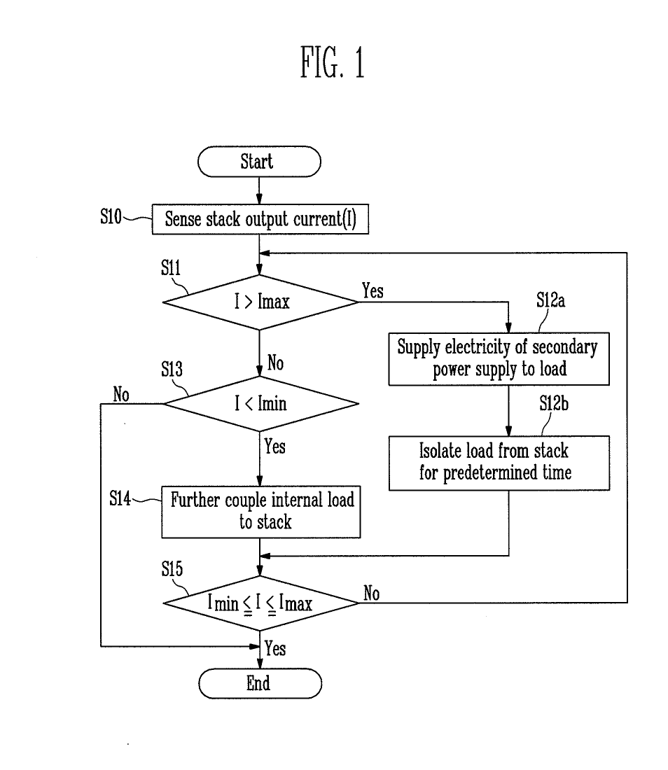

FIG. 1 is a flow chart of an embodiment of a method for operating an air-breathing-type polymer electrolyte membrane fuel cell.

Referring to FIG. 1, in step S10, a controller coupled to an air-breathing-type fuel cell stack senses an output current (I) of a fuel cell stack through a current sensor when starting or operating the fuel cell stack. In an air-breathing-type fuel cell stack, air from the atmosphere is supplied to a cathode electrode of the fuel cell stack by natural convection without using a forced air supplying means such an air pump, a fan, etc.

Thereafter, in step S11, a controller judges if the sensed output current (I) exceeds a maximum reference value, that is, a maximum current reference value (Imax). An output current (I) that exceeds the maximum reference value will raise the stack temperature excessively. Under these conditions, in step S12a, a load supplied with electricity from the stack is supplied with electricity from a secondary power supply to prevent a temperature rise in the stack, thereby preventing dehydration of MEAs therein. The secondary power supply includes a battery and/or a super capacitor mounted to the fuel cell system. Also, the controller can electrically isolate the stack from the load for a predetermined time in step S12b, for example, for from about 0.01 seconds to about several seconds, in order to rapidly lower the output current of the stack when the electricity of the secondary power supply is supplied to the load.

Further, if the sensed output current (I) does not exceed the maximum reference value, it is compared with a minimum reference value, that is, the minimum current reference value (Imin) in step S13. If the output current (I) is below the minimum reference value, the load supplied with the electricity from the stack and an internal load are further coupled to the stack to prevent cathode flooding that can easily occur under low output current conditions in step S14, thereby raising the stack output current above the minimum reference value. If the output current (I) is not below the minimum reference value, the sensed output current (I) is positioned above the minimum reference value and below the maximum reference value so that the operating process is completed.

In step S15, the controller determines if the output current (I) sensed after the steps S12a and S12b, or step S14 is below the maximum reference value and above the minimum reference value. If the high output current (I) is in the predetermined range, the operating process is completed. If the output current (I) is not in the predetermined range, the controller returns to step S11 to perform the process for operating the fuel cell.

According to the present embodiment, the output current is maintained in a predetermined range when starting or operating the fuel cell stack so that the fuel cell system equipped with the air-breathing-type polymer electrolyte membrane fuel cell stack can be stably started and operated for a long time.

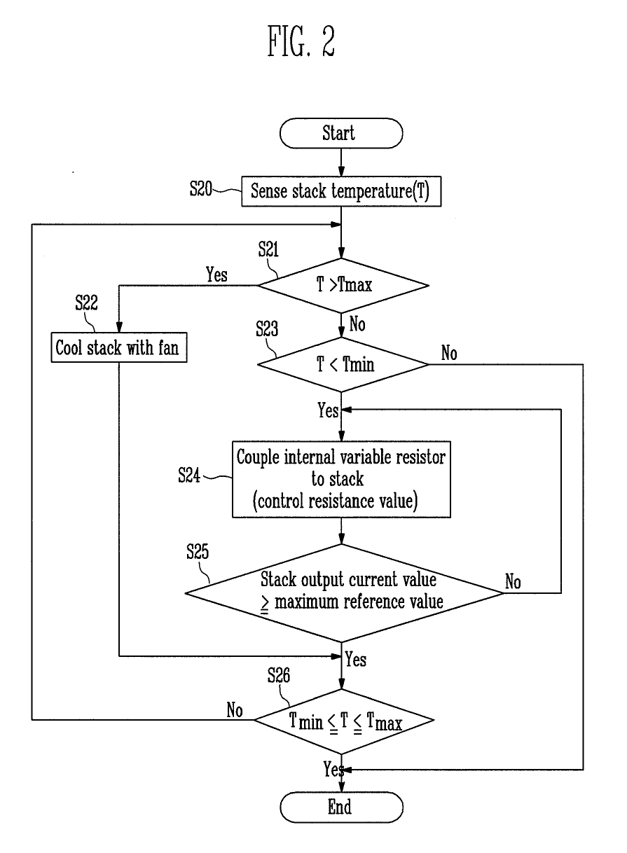

FIG. 2 is a flow chart of an embodiment of a method for operating an air-breathing-type polymer electrolyte membrane fuel cell.

Referring to FIG. 2, a controller coupled to an air-breathing-type fuel cell stack senses a temperature (T) of a fuel cell stack through a current sensor when starting or operating the fuel cell stack in step S20.

Thereafter, the controller judges if the sensed stack temperature (T) exceeds a maximum reference value, that is, a maximum temperature reference value (Tmax) in step S21. In step S22, if the stack temperature (T) exceeds the maximum reference value, the stack is cooled using the cooler such as a fan, etc., in order to prevent dehydration of the MEA inside the stack by the high stack temperature.

Further, if the sensed stack temperature (T) does not exceed the maximum reference value, the controller judges if the sensed stack temperature (T) is below the minimum reference value in step S23. In step S24, if the stack temperature (T) is below the minimum reference value, that is, a minimum temperature reference value (Tmin), an internal load are further coupled to the stack in addition to the load supplied by the stack, thereby preventing cathode flooding that can easily occur under low stack temperatures. It is exemplary that the internal load is a variable resistor. The resistance value of the variable resistor may be controlled to any resistance value until the output current of the stack has the maximum reference value or is near the maximum reference value. The stack is further electrically coupled to the variable resistor so that the output current of the stack is rapidly increased, making it possible to rapidly raise the stack temperature to a desired temperature. If the stack temperature (T) is not below the minimum reference value in step S23, the sensed stack temperature (T) is above the minimum reference value and below the maximum reference value and the operating process is completed.

Meanwhile, the controller judges if the stack temperature (T) sensed after the step S22 or steps S24 and S25 is below the maximum reference value and above the minimum reference value in step S26. If the stack temperature (T) is within the predetermined range, the operating process is completed. If the stack temperature (T) is not in the predetermined range, the controller returns to step S21 to repeat the operating process.

According to the present embodiment, the stack temperature is maintained in a predetermined range when starting or operating the fuel cell stack so that the fuel cell system equipped with the air-breathing-type polymer electrolyte membrane fuel cell stack can be stably started and operated for a long time.

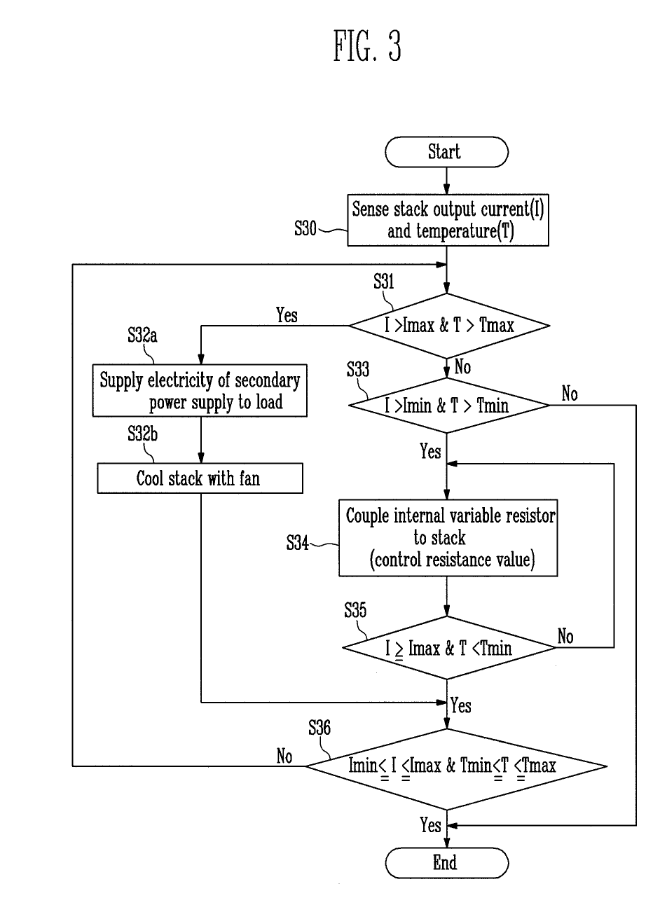

FIG. 3 is a flow chart of an embodiment of a method for operating an air-breathing-type polymer electrolyte membrane fuel cell.

Referring to FIG. 3, a controller coupled to an air-breathing-type fuel cell stack senses an output current (I) and a stack temperature (T) of a fuel cell stack through a current sensor and a temperature sensor when starting or operating the fuel cell stack in step S20.

Thereafter, the controller judges if the sensed output current (I) is above a maximum current reference value (Imax) and the sensed stack temperature (T) is above a maximum temperature reference value (Tmax) in step S31. If the output current (I) and the stack temperature (T) exceed their respective maximum reference values, a load supplied with electricity from the stack is supplied with electricity from a secondary power supply to prevent dehydration of the MEA resulting from an excessive a high stack temperature and output current in step S32a. In step S32b, the controller automatically cools the stack by using a cooler such as a fan, etc.

Further, if the output current (I) and the stack temperature (T) do not exceed their respective maximum reference values, the controller judges if the sensed output current (I) is below the minimum current reference value and the sensed stack temperature (T) is below the minimum temperature reference value (Tmin) in step S33. In step S34, if the output current (I) and the stack temperature (T) are below their respective minimum reference values, the internal variable resistor is further coupled to the stack in addition to the load, thereby prevent cathode flooding due to a low output current and a low stack temperature. The controller adjusts the resistance value of the variable resistor by selecting a predetermined resistance value such that the output current of the stack is the same as or exceeds the maximum reference value in step S35. In step S35, the variable resistor set to desired resistance value is electrically coupled to the stack, thereby rapidly increasing the output current and the stack temperature to a desired temperature. In step S33, if the output current (I) and the stack temperature (T) are not below their respective minimum reference values, the controller judges that the current output current (I) and stack temperature (T) are in the predetermined range, that is, in the range above the minimum reference values and below the maximum reference values, respectively, so that the operating process is completed.

Meanwhile, in step S36, the controller judges if the output current (I) and the stack temperature sensed after steps S32a and S32b, or steps S34 and S35 are below the maximum reference values and above the minimum reference values. If the output current (I) and the stack temperature (T) are in the predetermined range, the operating process is completed, and if the output current (I) and the stack temperature (T) are not in the predetermined range, the controller returns to step S31 to repeat the operating process.

According to the present embodiment, the output current and temperature of the stack are maintained in predetermined ranges when starting and/or operating the fuel cell stack so that the fuel cell system equipped with the air-breathing-type polymer electrolyte membrane fuel cell stack can be stably started and operated for a long time.

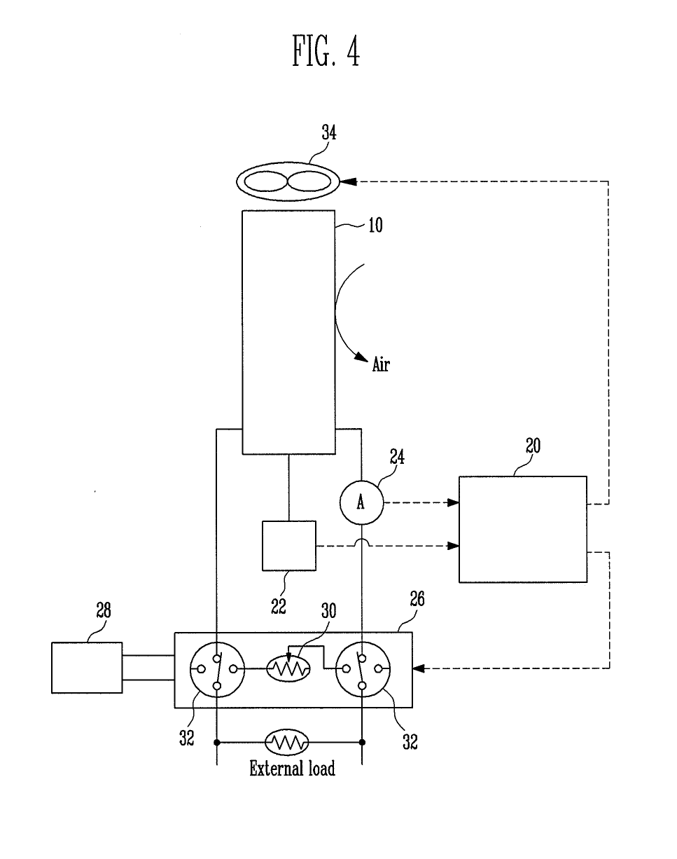

FIG. 4 is a schematic view of an embodiment of an air-breathing-type polymer electrolyte membrane fuel cell useful the operating method of the fuel cell described above.

Referring to FIG. 4, the air-breathing-type polymer electrolyte membrane fuel cell includes a fuel cell stack 10, a controller 20, a temperature sensor 22, a current sensor 24, a power converter 26, a secondary power supply 28, a variable resistor 30, a switching apparatus 32, and a cooler 34.

The fuel cell stack 10 includes an anode electrode, a cathode electrode, and an electrolyte membrane positioned between the anode electrode and the cathode electrode, which together comprise an electric generator that generates electricity by using fuel (hydrogen containing fuel) supplied to the anode electrode and air (oxygen) supplied to the cathode electrode by a natural convection. The electricity generator can comprise a dead-end type in which an end of the anode side channel supplied with fuel is closed, or as an open-end type in which an end of the anode side channel is open.

Also, the fuel cell stack 10 includes a fuel supplier supplying fuel to the electric generator. In other embodiments, the fuel supplier is separate from the fuel cell stack 10. The fuel supplier stores one or two kinds of mixed liquid-phase fuel, one or two kinds of mixed gas-phase fuel, or two phases of a liquid-phase fuel and a gas-phase fuel. The fuel supplier includes all the means and apparatuses that supply the stored fuel to the electric generator.

The controller 20 senses the output current (I) and/or the temperature (T) of the fuel cell stack (10) and controls a balance of plants (BOP) of the fuel cell system so that the output current and/or the temperature is maintained in a predetermined range. The controller 20 can comprise a logic circuit using a flip-flop or at least some function of a microprocessor operated by information stored in a memory and/or a program.

The temperature sensor 22 detects the temperature of the fuel cell stack 10 and transfers the information on the detected temperature to the controller 20. The current sensor 24 detects the current generated in the fuel cell stack 10 and transfers the information on the detected output current to the controller 20.

The power converter 26 converts electricity generated in the fuel cell stack 10 into a proper form and supplies it to the external load. The power converter 26 includes a means and an apparatus for converting direct current into alternating current, or direct current into direct current with a different form. For example, the power converter 26 includes at least any one of an analog to digital converter (ADC), a digital to analog converter (DAC), and a digital to digital converter.

The secondary power supply 28 includes all means and apparatuses for supplying electricity to the external load, together with the fuel cell stack 10 or alone, or supplying electricity to the balance of plants. For example, the secondary power supply 28 includes a power supplier such as a rechargeable secondary battery, a capacitor, and/or a super capacitor, etc., that can be mounted in the fuel cell system. Also, the secondary power supply 28 includes another fuel cell system and/or a power supply such as a commercial power supply, etc.

The variable resistor 30 is electrically coupled or isolated to and from the fuel stack 10 through the switching apparatus 32, and comprises a resistor configured to be able to change the resistance value. The variable resistor 30 is an internal load that is mounted in the fuel cell system and the resistance vale of the variable resistor 30 can be controlled according to the performance of the fuel cell stack and the size in the external load coupled to the stack.

The switching apparatus 32 electrically couples or isolates the fuel cell stack 10 to and from the external load and/or the variable resistor 30. It also couples or isolates the secondary power supply 28 to and from the external load, together with the fuel cell stack 10 or separately. The switching apparatus 32 can comprise a mechanical switch using a machine, an electronic switch using a transistor, or a semiconductor device or a switch comprising a combination thereof.

Although the foregoing variable resistor 30 and the switching apparatus 32 included in the power converter 26 are shown in FIG. 4, other embodiments use other configurations in which the variable resistor 30 and/or the switching apparatus 32 comprises an independent apparatus that is not included in the power converter 26.

The cooler 34 includes all means and apparatuses capable of cooling the fuel cell stack 10. For example, the cooler 34 includes a fan directing an air flow to the fuel cell stack 10 and an apparatus or a heat exchanger producing a coolant flow penetrating through the fuel cell stack and/or to the outside surface thereof.

According to the present embodiment, when starting or operating the fuel cell stack 10, the output current and/or the stack temperature are maintained in a predetermined range using any one of the secondary power supply 28, the variable resistor 30, the switching apparatus 32, the cooler 34, and combinations thereof as described above. Accordingly, dehydration of MEA and cathode flooding of the fuel cell stack 10 can be prevented and the system can be stably started and operated.

FIG. 5 is a schematic view of an embodiment of an electric generator 10a useful in an air-breathing-type electrolyte membrane fuel cell.

Referring to FIG. 5, an electric generator 10a included in the fuel cell stack 10 described above includes an anode electrode, a cathode electrode, and an electrolyte membrane 11 positioned between the anode electrode and the cathode electrode.

The anode electrode of the electric generator 10a according to the present embodiment includes an anode catalyst layer 12, an anode microporous layer 14, and an anode diffusion layer 16. The cathode electrode includes a cathode catalyst layer 13, a cathode microporous layer 15, and a cathode diffusion layer 17.

Proton conductive polymers suitable as the electrolyte membrane 11 include fluoro-based polymers, ketonic polymers, benzimidazole-based polymers, ester-based polymers, amide-based polymers, imide-based polymers, sulfonic polymers, styrene-based polymers, hydrocarbon polymers, etc. Examples of the proton conductive polymer include, without limitation, poly(perfluorosulfonic acid), poly(perfluorocarboxylic acid), tetrafluoroethylene including a sulfonate group, fluorovinylether copolymer, defluorinated sulfide polyetherketone, aryl ketone, poly(2,2′-(m-phenylene)-5,5′-bibenzimidazole), poly(2,5-benzimidazole), polyimide, polysulfone, polystyrene, polypheneylene, etc. Also, the proton conductive polymer may comprise acid doped polybenzimidazole, which can be applied at a temperature of from about 100° C. to about 200° C., as a main component.

Solvent may be used to manufacture the electrolyte membrane 11. At this time, the solvent comprises one or a mixture of at least two of ethanol, isopropyl alcohol, n-propyl alcohol, butyl alcohol, water, dimethylsulfoxide (DMSO), dimethylacetamide (DMAc), and N-methylpyrolidone (NMP).

The catalyst layer of the anode electrode 12 and catalyst layer of the cathode electrode 13 catalyze the chemical reactions of the fuel and oxidant, respectively. Preferably, the catalyst layer includes at least one metal catalyst selected from a group consisting of platinum, ruthenium, osmium, an alloy of platinum-ruthenium, an alloy of platinum-osmium, an alloy of platinum-palladium, and an alloy of platinum-M, where M is at least one transition metal selected from a group consisting of Ga, Ti, V, Cr, Mn, Fe, Co, Ni, Cu, and Zn. On the other hand, the catalyst may include at least one metal catalyst selected from the group consisting of platinum, ruthenium, osmium, an alloy of platinum-ruthenium, an alloy of platinum-osmium, an alloy of platinum-palladium, and an alloy of platinum-M, where M is at least one transition metal selected from the group consisting of Ga, Ti, V, Cr, Mn, Fe, Co, Ni, Cu, and Zn, which is impregnated in a carrier. Any material with suitable conductivity can be used as the carrier, but it is exemplary to use a carbon carrier.

The microporous layers of the anode electrode 14 and the cathode electrode 15 function to uniformly distribute and supply fuel or oxidant to the respective catalyst layers 12 and 13. In particular, the microporous layer of the cathode 15 side functions to smoothly exhaust water generated from the catalyst layer of the cathode 13 side. The respective microporous layers 14 and 15 described above can comprise carbon layers coated on the respective backing layers 16 and 17. Also, the microporous layers 14 and 15 may include at least one carbon material selected from a group consisting of graphite, carbon nanotubes (CNT), fullerene (C₆₀), activated carbon, Vulcan® carbon black (Cabot), Ketjen black (Akzo), carbon black, and carbon nanohom, and further include at least one binder selected from a group consisting of poly(perfluorosulfonic acid), poly(tetrafluoroethylene), and fluorinated ethylene-propylene.

The backing layers of the anode electrode 16 and the cathode electrode 17 function to back each catalyst layer 12 and 13 and at the same time, to distribute fuel, water, air, etc., to collect electricity generated, and to prevent loss of materials from each catalyst layer 12 and 13. The backing layers 16 and 17 described above can comprise carbon base materials, such as carbon cloth, carbon paper, etc.

In brief, when starting and operating the air-breathing-type fuel cell stack where the microporous layers 14 and 15 are mounted in the anode electrode and the cathode electrode, respectively, dehydration in the MEA including the anode electrode, the cathode electrode, and the electrolyte membrane positioned therebetween is suppressed by using the operating method described above, under which the fuel cell stack can be started and operated under the high temperatures and with a high output. The maximum reference values for the output current and the stack temperature can be set according to whether the air-breathing-type polymer electrolyte membrane fuel cell stack comprises the microporous layers.

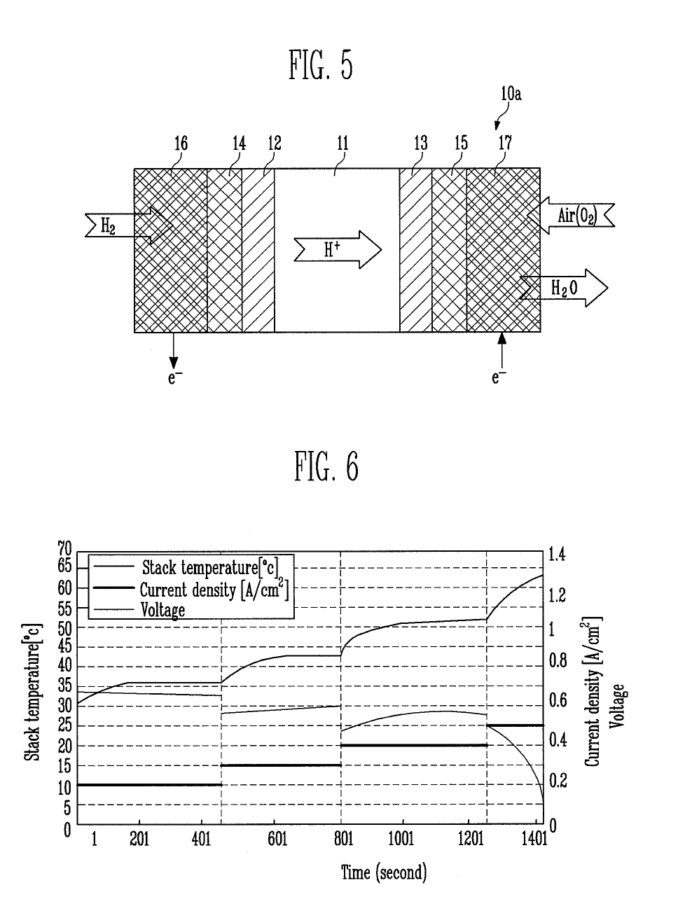

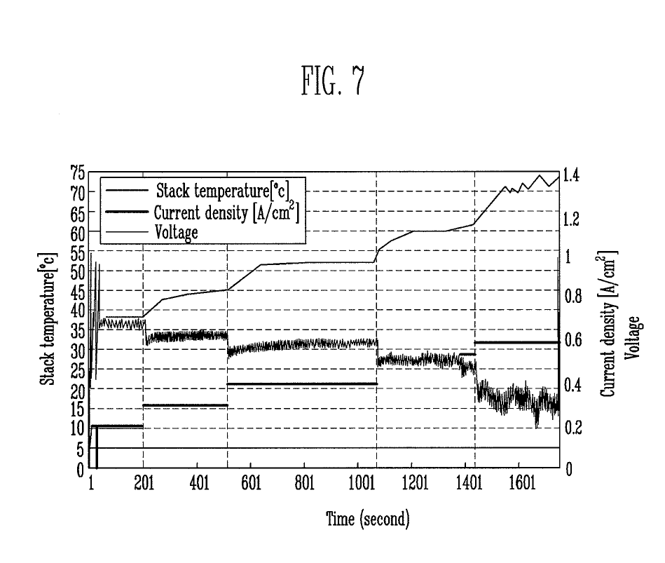

FIG. 6 is a graph showing performance according to output current density and stack temperature of a general air-breathing-type polymer electrolyte membrane fuel cell.

FIG. 6 illustrates the performance of a general air-breathing-type polymer electrolyte membrane fuel cell. A maximum output current of 400 mA/cm² is reached in 800 seconds to 1200 seconds. When the output current reaches about 500 mA/cm², the output voltage of the stack rapidly drops, shutting down the stack. Therefore, in order to stably start and operate the general air-breathing-type polymer electrolyte membrane fuel cell used in this example, the maximum current density is kept below about 400 mA/cm², which is also the maximum current density in some embodiments of the method discussed above.

The performance of the general air-breathing-type polymer electrolyte membrane fuel cell is significantly reduced by cathode flooding when the output current of the stack is below about 200 mA/cm². Therefore, in order to stably start and operate the general air-breathing-type polymer electrolyte membrane fuel cell, the output current of the stack is kept above about 200 mA/cm², which is also the minimum current density in some embodiments of the method discussed above.

Also, in the general air-breathing-type polymer electrolyte membrane fuel cell, dehydration of the MEA occurs when the temperature exceeds about 50° C. and the cathode flooding occurs when the temperature is below about 36° C. Therefore, in order to stably start and operate the general air-breathing-type polymer electrolyte membrane fuel cell, the stack temperature is kept above about 36° C. and below about 50° C., which is also the temperature range in some embodiments of the method discussed above. In FIG. 6, a starting period is from after starting the stack to about 200 seconds. This period is excluded from the applied period of the operating method in some embodiments.

The foregoing general air-breathing-type polymer electrolyte membrane fuel cell does not comprise microporous layers in the anode electrode or the cathode electrode. Therefore, in embodiments in which the anode electrode and the cathode electrode comprise microporous layers, the maximum current density of the stack can exceed about 400 mA/cm².

FIG. 7 is a graph a graph showing performance according to current density and temperature of a stack of a general air-breathing-type polymer electrolyte membrane fuel cell using the operating method of the fuel cell described above.

In the present embodiment, the electric generator in the air-breathing-type polymer electrolyte membrane fuel cell system or the fuel cell stack comprises microporous layers on the anode electrode and the cathode electrode.

Referring to FIG. 7, in the air-breathing-type polymer electrolyte membrane fuel cell according to the present embodiment, the output current of the stack is controlled so that the current density of the stack is in the range of from about 200 mA/cm² to about 600 mA/cm² or less, thereby stably starting and operating the stack for a long time.

Also, in the air-breathing-type polymer electrolyte membrane fuel cell according to the present embodiment, the stack temperature is controlled in the range of from about 38° C. to about 70° C., thereby stably starting and operating the stack for a long time. For reference, as shown in FIG. 7, the period of 1500 seconds to 1750 seconds is a period in which the stack temperature exceeds 70° C., and the stack performance is slightly unstable.

The system is controlled to keep the output current of the stack and/or the stack temperature in a predetermined range so that the air-breathing-type polymer electrolyte membrane fuel cell is stably started and operated and its reliability is improved.

As described above, the output current of the air-breathing-type fuel cell stack is controlled so that the stack and system are stably operated. Also, embodiments in which the anode electrode and/or the cathode electrode comprise a diffusion layer with a microporous layer can control the current density and stack temperature of the stack in the high output and high temperature conditions, as compared to embodiments not comprising a diffusion layer with a microporous, thereby stably operating the high performance system. Also, the output current of the stack is controlled in a predetermined range so that the initial driving time of the system can be shortened through a high current operation in a low output state.

Although exemplary embodiments have been shown and described, it would be appreciated by those skilled in the art that changes might be made in these embodiments without departing from the principles and spirit thereof, the scope of which is defined in the claims and their equivalents.

What is claimed is:

1. A method for operating an air-breathing-type polymer electrolyte membrane fuel cell comprising a fuel cell stack comprising an anode electrode, a cathode electrode, and a polymer electrolyte membrane disposed therebetween, the method comprising:
detecting an output current of a fuel cell stack;
comparing the detected output current with a maximum reference current value and a minimum reference current; and
maintaining the output current below the maximum reference current value and above the minimum reference current value.

2. The method as claimed in claim 1, further comprising, electrically coupling a secondary power source to an external load electrically coupled to the fuel cell stack when the output current exceeds the maximum reference current value.

3. The method as claimed in claim 2, further comprising electrically isolating the fuel cell stack from the load for a predetermined time.

4. The method as claimed in claim 1, further comprising electrically coupling a separate internal load with predetermined resistance to the fuel cell stack in addition to an external load electrically coupled thereto when the output current is below the minimum reference current.

5. The method as claimed in claim 1, wherein the maximum reference current is about 600 mA/cm² and the minimum reference current is about 200 mA/cm².

6. The method as claimed in claim 1, wherein at least one of the anode electrode and the cathode electrode comprises a catalyst layer, a diffusion layer, and a microporous layer.

7. A method for operating an air-breathing-type polymer electrolyte membrane fuel cell comprising a fuel cell stack comprising an anode electrode, a cathode electrode, and a polymer electrolyte membrane disposed therebetween, the method comprising:
detecting a temperature of a fuel cell stack;
comparing the detected temperature with a maximum reference temperature and a minimum reference temperature; and
maintaining the stack temperature below the maximum reference temperature and above the minimum reference temperature.

8. The method as claimed in claim 7, further comprising cooling the fuel cell stack using a cooling device coupled to the fuel cell stack when the stack temperature exceeds the maximum reference temperature.

9. The method as claimed in claim 7, further comprising electrically coupling an internal variable resistor to the fuel cell stack, thereby operating the fuel cell stack for a predetermined time at an output current density exceeding a maximum output current density when the fuel cell stack temperature is below the minimum reference temperature.

10. The method as claimed in claim 7, wherein the maximum reference temperature is about 50° C. and the minimum reference temperature is about 36° C.

11. A method for operating an air-breathing-type polymer electrolyte membrane fuel cell comprising a fuel cell stack comprising an anode electrode, a cathode electrode, and a polymer electrolyte membrane disposed therebetween, the method comprising:
detecting an output current and a temperature of a fuel cell stack;
comparing the detected output current to a maximum reference current and a minimum reference current, and comparing the detected temperature to a maximum reference temperature and a minimum reference temperature; and
maintaining the output current below the maximum reference current and above the minimum reference current, and maintaining the temperature below the maximum reference temperature and above the minimum reference temperature.

12. The method as claimed in claim 11, further comprising electrically coupling a secondary power source to a load electrically coupled to the fuel cell stack and cooling the fuel cell stack using a cooling device coupled to the fuel cell stack when the output current and stack temperature exceed their respective maximum reference values.

13. The method as claimed in claim 11, further comprising, electrically coupling a separate internal load with predetermined capacity to the fuel cell stack in addition to an external load electrically coupled thereto when the output current and stack temperature are below their minimum reference values.

14. An air-breathing-type polymer electrolyte membrane fuel cell comprising:
a fuel cell stack comprising an anode electrode, a cathode electrode, and a polymer electrolyte membrane positioned therebetween;
an electric generator comprising the fuel cell stack and operable for generating electric energy by an electrochemical reaction between a fuel supplied to the anode electrode and oxygen is supplied to the cathode by convection;
a fuel supplier fluidly connected to the anode electrode;
an output current detector electrically coupled to the electric generator; and
a controller electrically coupled to the output current detector, and driving at least one performance maintenance device operable to maintain an output current value below a maximum reference current value and above a minimum reference current value.

15. The fuel cell as claimed in claim 14, wherein
the performance maintenance device comprises a secondary power supply; and an internal load,
the controller is configured to electrically couple and uncouple an external load to and from one or both of the electric generator and the secondary power supply,
the controller is configured to electrically couple and uncouple the internal load to and from the electric generator,
the controller is configured to electrically couple the secondary power supply to the external load when the output current value exceeds the maximum reference current value, and
the controller is configured to electrically couple the internal load to the electric generator in addition to the external load when the output current value is below the minimum reference current value.

16. The fuel cell as claimed in claim 14, wherein at least one of the anode electrode and the cathode electrode comprises a catalyst layer, a diffusion layer, and a microporous layer.

17. An air-breathing-type polymer electrolyte membrane fuel cell comprising:
a fuel cell stack comprising an anode electrode, a cathode electrode, and a polymer electrolyte membrane disposed therebetween;
an electric generator comprising the fuel cell stack and operable for generating electric energy by an electrochemical reaction between a fuel supplied to an anode electrode and oxygen supplied to the cathode by convection;
a fuel supplier fluidly connected to the anode electrode;
a temperature detector operable for detecting a temperature of the electric generator; and
a controller electrically coupled to an output of the temperature controller and driving at least one performance maintaining device operable to maintain the temperature of the electric generator below a maximum reference temperature value and above a minimum reference temperature value.

18. The fuel cell as claimed in claim 17, wherein
the performance maintaining device comprises a cooling device configured for cooling the electric generator and an internal variable resistor electrically coupled to the electric generator through a switch,
the controller is configured to activate the cooling means, thereby cooling the electric generator when the temperature of the electric generator exceeds the maximum reference temperature value, and
the controller is configured to electrically couple the variable resistor to the electric generator and adjusts the resistance value of the variable resistor, thereby adjusting the output current of the electric generator to about a maximum reference current value when the temperature of the electric generator is below the minimum reference temperature value.

19. The fuel cell as claimed in claim 17, wherein at least one of the anode electrode and the cathode electrode comprises a catalyst layer, a diffusion layer, and a microporous layer.

20. An air-breathing-type polymer electrolyte membrane fuel cell comprising:
a fuel cell stack comprising an anode electrode, a cathode electrode, and a polymer electrolyte membrane disposed therebetween;
an electric generator comprising the fuel cell stack, operable for generating electric energy by an electrochemical reaction between a fuel supplied to the anode electrode and oxygen supplied to the cathode by convection;
a fuel supplier fluidly connected to the anode electrode;
a detector configured for detecting an output current of the electric generator and a temperature of the electric generator; and
a controller electrically coupled to the output of the detector and configured for driving at least one performance maintaining device operable maintain at least one of the output current and temperature their respective predetermined minimum reference value and maximum reference value.

21. The fuel cell as claimed in claim 20, wherein
the performance maintaining device comprises a secondary power supply; a cooling device configured for cooling the electric generator; and a variable resistor coupled to the electric generator through a switch, and
the controller is configured to electrically couple and uncouple an external load to and from one or both of the electric generator and the secondary power supply,
the controller is configured to activate and deactivate the cooling device,
the controller is configured to electrically couple and uncouple the internal load to and from the electric generator,
the controller is configured to electrically couple the secondary power supply to the external load and activates the cooling device, thereby cooling the electric generator when at least one of the output current value and the temperature value exceeds their respective maximum reference values, and
the controller electrically couples the variable resistor to the electric generator and adjusts the resistance thereof, thereby adjusting the output current value of the electric generator to equal to or larger than a maximum reference current value when at least one of the output current value and the temperature value is below the minimum reference value.

22. The fuel cell as claimed in claim 20, wherein at least one of the anode electrode and the cathode electrode comprises a catalyst layer, a diffusion layer, and a microporous layer.
